(19) United States
(12) Patent Application Publication
(10) Pub. No.: US 2026/0264911 A1
(43) Pub. Date: Sep. 10, 2026

(54) PROCESSING DEVICE AND USE

(71) Applicant: TT INNOVATION AG, Zug (CH)

(72) Inventors: Simon Daniel Henzmann, Basel (CH); Florian HUELIN, Windisch (CH); Tobias Patrick DE MADDALENA, Kaiseraugst (CH)

(73) Assignee: TT INNOVATION AG, Zug (CH)

(21) Appl. No.: 18/720,976

(22) PCT Filed: Jul. 18, 2023
(86) PCT No.: PCT/EP2023/069969

§ 371 Date: Jun. 17, 2024

(30) Foreign Application Priority Data
Jul. 22, 2022 (EP) 22186443.2

(51) Int. Cl. B65B 43/54; B65B 7/28

(52) U.S. Cl. CPC B65B 43/54; B65B 7/28; B65B 7/161; B65B 43/42; B65G 54/02

(57) ABSTRACT

A processing device (1) with at least one processing station (2) and at least one transport device (3), the transport device (3) being configured to transport at least one magnetically levitated transport unit (4), configured to receive a processing object (6), to and/or from the at least one processing station (2), with the processing station (2) being configured to apply a processing force (F) to the processing object (6), and the processing station (2) having at least one support unit (7), to which the at least one transport unit (4) can be coupled, and the support unit (7) forming an abutment (8) against the processing force (F).

### CROSS-REFERENCE TO RELATED APPLICATIONS

This application is the U.S. National Phase of PCT Appln. No. PCT/EP 2023/0699692, filed Jul. 18, 2023, which claims priority from European Patent Application No. 22186443.2, filed Jul. 22, 2022, the entire disclosures of which are incorporated by reference herein.

### TECHNICAL FIELD

The invention relates to a processing device with at least one processing station and at least one transport device, the transport device being configured to transport at least one magnetically levitated transport unit, configured to receive a processing object, to and/or from the at least one processing station, the processing station being configured to apply a processing force to the processing object.

Furthermore, the invention relates to the use of a processing device.

### BACKGROUND

Processing devices of this type are used, for example, to close, in particular, pharmaceutical units, with the result that individual parts of the units can no longer be disconnected from one another. Furthermore, pharmaceutical devices and/or medical devices can be assembled. Here, the processing force which is to be applied by way of the processing station can be high. This processing force which can be, in particular, a compressive and/or tensile force and/or a torque and/or a torsional force is dissipated via the magnetically levitating transport unit which preferably transports the processing object to the processing station, which is disadvantageous. It can be disadvantageous, in particular, that the dissipated processing force is dissipated to an electromagnetic stator arrangement, to which the transport unit is coupled magnetically, since this can preferably act as an abutment. In this way, the transport device can be damaged, as a result of which processes are prevented or at least slowed down. Furthermore, maintenance or repair costs of the transport device can be considerable, which can have a negative effect on the product costs.

It is known that the processing force in the case of a processing station can be limited on account of the abovementioned disadvantages. This limiting can result in it being possible for processing objects to be processed, for example closed, only insufficiently. In this way, certain quality standards cannot be achieved, which can be disadvantageous, in particular, for devices in pharmaceutical production.

### SUMMARY

The object of the invention which is based, in particular, on the stated disadvantages consists in improving processing devices.

According to the invention, one or more of the features disclosed herein are provided to achieve the stated object. Therefore, in particular, it is proposed according to the invention in order to achieve the stated object in the case of a processing device of the type described at the outset that the processing station has at least one support unit, to which the at least one transport unit can be coupled, and the support unit forming an abutment against the processing force. The processing force which acts on the transport unit can be reduced by way of the support unit, with the result that the durability of the transport unit and/or the transport device can be improved. By virtue of the fact that the support unit configures an abutment against the processing force, the processing force can be very high, as a result of which processing of processing objects, in particular closing of pharmaceutical units, can be carried out particularly satisfactorily. Overall, a wide spectrum of processing forces can be used in a processing device as a result of the use of a support unit, with the result that the processing device can process a large number of different processing objects, preferably in a protected space, which is economically advantageous. Processing objects of this type can be, in particular: vials, syringes or carpules. Medical devices, in particular medical apparatuses such as autoinjectors, also come into consideration as processing objects.

Furthermore, processing of the processing object by way of the processing device according to the invention can take place even when the levitating transport unit moves vertically or obliquely along a stator arrangement as described herein, since the support unit can prevent the transport unit from being pressed in the direction of the ground by way of the processing force. This in particular can improve a processing device.

Furthermore, it is advantageous in the case of the processing device according to the invention that ripping out of the magnetically levitatable transport unit can be prevented in the case of a vertically and/or obliquely arranged stator arrangement, in particular as described and/or claimed in the following text, in particular if a processing force is applied to the magnetically levitatable transport unit.

The invention makes it possible for processing forces to be applied to the transport unit, which processing forces exceed a holding force of the transport unit, given by way of an action mechanism of the transport device, for example.

“Can be coupled” can be understood to mean, for example, that the at least one transport unit is configured such that it can be moved into the support unit and/or can be connected to the support unit. Therefore, the at least one transport unit can be moved into the support unit and/or can be connected releasably to the support unit in an optimum manner.

The at least one transport unit can also be of movable configuration, with the result that the transport unit can be lifted and/or moved and/or positioned, in particular, by way of the support unit. Therefore, a transport path of the transport unit can advantageously be extended by way of the support unit.

It is one advantage of the invention that processing forces which are to be applied to the transport device can be reduced. This can help to reduce or avoid damage of the transport units or the transport device overall.

For example, it can be prevented by way of the abutment that the magnetically levitated transport unit is pressed onto the stator arrangement during the processing, and the processing force is dissipated to the stator arrangement. It can be prevented as a result that the stator arrangement is damaged or destroyed. This is advantageous, in particular, for the durability and production efficiency of the processing device according to the invention.

The magnetically levitatable transport unit is coupled magnetically to the stator arrangement; magnetic coupling of the magnetically levitatable transport unit to the stator arrangement is to be understood to mean any magnetic coupling which is known to a person skilled in the art. Here, the stator arrangement can be configured to generate a magnetic field which is variable in a controlled manner and which levitates and/or moves the magnetically levitatable transport unit.

Magnetic coupling can thus be realized by way of electromagnetic coupling of the magnetically levitatable transport unit to the stator arrangement. Here, the stator arrangement can comprise at least one electromagnet. The magnetically levitatable transport unit can have, for example, at least one permanent magnet, or can be of magnetically active and/or responsive configuration in some other way.

As an alternative or in addition, both the stator arrangement and the magnetically levitatable transport unit can each comprise at least one permanent magnet. Here, a movement of the transport unit can be initiated, ended and/or controlled, in particular, by a change of the magnetic field which is configured by the stator arrangement. Therefore, the stator arrangement can comprise, in particular, movable permanent magnets which are in and/or can be brought into an operative connection with the magnetically levitatable transport unit. The movable permanent magnets can be driven by motor, for example. A magnetic field which is variable in a controlled manner can thus be generated by way of a controlled movement of the permanent magnets, which magnetic field can be used to drive a movement of the magnetically levitatable transport unit. Furthermore, it can be provided, for example, that the stator arrangement is configured with at least one electropermanent magnet.

The support unit is adapted to a transport unit in such a way that the transport unit can be coupled, in particular can be moved and/or can be connected, to the support unit, and that the support unit can form an abutment. It can also be provided that the or a support unit is configured such that it can be adapted to transport units of different design. As an alternative or in addition, the support unit can also be configured in such a way that a plurality of transport units can be coupled, preferably moved or connected, at the same time to the support unit. In this way, the same processing station can advantageously process transport units of different design and/or a plurality of transport units at the same time, with the result that a processing device can be used even more flexibly.

It can also be provided that the support unit or the abutment is configured by way of at least one transport unit, particularly preferably by way of at least two transport units. In this way, the support unit can advantageously be of mobile configuration. In the case of the use of a plurality of transport units as abutments, in particular, high holding forces can be generated which can reach multiple times the holding force of a single transport unit. In this way, a position of a transport unit can be fixed during a processing operation.

It can be provided in the case of one advantageous refinement that the transport unit is configured with a variable spacing from an electromagnetic stator arrangement at least in the support unit, it preferably being possible for a volume between the transport unit and the stator arrangement to be increased. As a result, for example by way of a stroke movement, the distance or the (covered) volume between the transport unit and the stator arrangement can be increased before and/or during the processing of the processing object. In this way, dissipation of the processing force to the stator arrangement can advantageously be reduced even further or prevented. Furthermore, coupling of the transport unit to the support unit can be carried out in a controlled manner, which can be particularly advantageous.

It can be provided, in particular, that the spacing is of variable configuration by way of energization of a (for example, the abovementioned) stator arrangement. In this way, the spacing change of the transport unit can be carried out by way of the transport device and/or the further stator arrangement. As a result, the support unit can be configured in a spatially fixed manner on the processing station, as a result of which the support unit can be used as an abutment against particularly high processing forces.

The further stator arrangement can be configured, in particular, on the processing station which, in particular, is not connected to the transport device. The further stator arrangement can be configured, for example, as a second stator arrangement of a first or second transport device, it being possible for the second stator arrangement to be configured, for example, vertically or horizontally with respect to the first stator arrangement of the transport device.

It can be provided in the case of one advantageous refinement that the support unit configures an active component and lifts and/or supports the transport unit at least partially. As an active component, the support unit can be moved, in order to advantageously lift off and/or to support the transport unit, in particular if the processing force is dissipated to the transport unit. For example, the processing force can be absorbed by way of the support unit, with the result that the transport unit and, in particular, the stator arrangement are loaded slightly and/or are not loaded at all. As a result, a transport device can advantageously be protected.

It can be provided in the case of one advantageous refinement that the support unit is arranged in a spatially fixed manner with respect to the processing station. This is advantageous, in particular, when, as described herein, the spacing of the transport unit from an electromagnetic stator arrangement is of variable configuration by way of energization of the stator arrangement described herein. It can be provided in the case of one advantageous refinement that the support unit is arranged movably. As a result, after it has moved into the support unit, the transport unit can be moved relative to the stator arrangement by way of the support unit. In this way, the spacing between the transport unit and the stator arrangement can advantageously be increased.

The support unit can preferably be arranged such that it can be moved relative to the processing station. As a result, the support unit can be moved into a parked and/or processing position.

It can be provided, in particular, that a drive can be brought about by way of the transport device. In this way, the support unit can be configured such that it can be moved in a relative manner by way of the transport device. For example, the support unit can be capable of being levitated magnetically, and can be driven by way of the stator arrangement which is described herein and/or a stator arrangement which is preferably arranged on the processing station. In this way, the drive of the support unit can advantageously take place by way of the energization described herein of the stator arrangement. It is advantageous here that a transport device can be used to move the transport unit and the support unit, which can have structural, technical and financial advantages.

The support unit can preferably be configured by way of at least two transport units of the or a further transport device. These two transport units are preferably of magnetically levitatable configuration, in order to advantageously be moved on the or a further stator arrangement, in particular as described herein. In this way, a relative movement of the support unit and the magnetically levitated transport unit which is configured to receive the processing object can additionally be carried out, in particular in order to advantageously dissipate the processing force of the processing device. It can be provided in the case of one advantageous refinement that the abutment is configured in a fitting manner with respect to a counter-abutment on the at least one transport unit. As a result, a processing force can be dissipated in an optimum manner by way of the abutment which is configured in a fitting manner with respect to the counter-abutment. In this way, a connection which is positively locking and/or non-positive and/or brought about via magnetic forces can advantageously be established between the transport unit and the support unit.

It can be provided in the case of one advantageous refinement that the abutment is configured in such a way that the supported transport unit is arranged spaced apart from the stator arrangement even in the case of a deactivated transport device. In particular, this can be provided if, as described above, the transport unit is configured with a variable spacing from the electromagnetic stator arrangement at least in the support unit. In this way, the stator arrangement can advantageously be switched off during processing, and energy can be saved. Furthermore, it can be advantageous that a sensor system which is situated on the transport unit and is sensitive, for example, to electromagnetic fields is protected by the distance. In this way, the sensitive sensor system can be used in the case of the processing device for processing, in particular, the processing object.

It can be provided in the case of one advantageous refinement that the abutment is arranged in such a way that the at least one transport unit makes contact with the abutment within its stroke travel. In this way, the abutment or the support unit can advantageously be moved relative to the processing station by way of the drive of the transport device.

It can be provided in the case of one advantageous refinement that the abutment is arranged parallel and/or transversely, in particular perpendicularly, with respect to the stator arrangement. In this way, the transport unit can be coupled or moved and/or connected to the support unit in a simple manner, in order to establish a contact in a contact region, as described in the following text, between the abutment and the counter-abutment. For example, a parallel-arranged abutment can facilitate moving in of the transport unit. A transversely, in particular perpendicularly arranged abutment is particularly advantageous if the transport unit is moved on a vertical stator arrangement and is coupled for processing on the processing device, since, for example, the abutment can be used, in particular, even as a blocking means of one degree of freedom.

It can be provided, in particular, that the abutment has an extent which is at least 1.2 times longer than a contact region between the abutment and the counter-abutment. This can ensure that the transport unit makes contact with the support unit completely in the region of its counter-abutment. In this way, a homogeneous dissipation of the processing force can be ensured, which is advantageous for the safety of the transport unit and the processing object.

As an alternative, it can be provided, in particular, that the abutment has an extent which is at most 1.2 times longer than a contact region between the abutment and the counter-abutment. In this way, the at least one transport unit can be oriented on or coupled to the support unit precisely.

It can be provided in the case of one advantageous refinement that the processing station is configured to apply a tensile force and/or a compressive force and/or a torque as a torsional force as the processing force. As a result, a processing device can process processing objects in a variable manner, as a result of which processes can be configured particularly multifariously.

It can be provided in the case of one advantageous refinement that the processing station has a press, by way of which the processing force can be applied. As a result, a processing object can be reshaped, pressed and/or closed, in particular, by way of a rectilinear relative movement.

It can be provided in the case of one advantageous refinement that the processing station has a load cell. As a result, a holding force and/or the or a processing force can advantageously be measured. In this way, a processing force can be adapted to a holding force in an optimum manner. Holding force means, for example, the force of the support unit, by way of which the transport unit is held in position, in particular, during the processing of the processing object.

It can be provided in the case of one advantageous refinement that the processing force is greater than the holding force of the transport unit. In this way, in particular when the transport unit is arranged at least in the support unit at a spacing from the electromagnetic stator arrangement described herein, a low holding force can be used. In this way, active engagement of the transport unit can advantageously be dispensed with at least during the processing.

It can be provided in the case of one advantageous refinement that the support unit is configured to block at least two degrees of freedom of the transport unit. This can be the case, for example, if the transport unit is moved into and held in a support unit which is configured as a two-pronged fork. In this way, it can be prevented that the transport unit carries out undesired movements (in the direction of the blocked degrees of freedom) during the processing. In this way, processing of processing objects can be robust, in particular, even in the case of high processing forces.

It can be provided in the case of one advantageous refinement that the abutment can be activated. In this way, the abutment can advantageously make contact with the counter-abutment of the transport unit by way of an activation. As a result, undesired contact between the or a transport unit and the support unit can advantageously be avoided. An activation can also take place, for example, via magnetic forces of permanent magnets and/or electromagnets.

It can be provided, in particular, that the abutment is activated by way of a (for example, the abovementioned) docking transport unit. In this way, the abutment can advantageously be activated by way of a docking transport unit which preferably carries a processing object. In this way, undesired activations can be prevented.

It can be provided in the case of one advantageous refinement that the abutment configures at least two contact surfaces with the counter-abutment. As an alternative, a plurality of contact surfaces can also be configured. For example, the support unit can be configured as a fork, each prong configuring a contact surface with the counter-abutment. As a result of the at least two contact surfaces, a force dissipation of the processing force can be of even more homogeneous and gentle configuration for the transport device.

It can be provided in the case of one advantageous refinement that the support unit is surrounded at least partially by the stator arrangement. This is advantageous, in particular, when the processing station itself has a stator arrangement, into which the transport unit can be moved. As a result, the processing station can be connected functionally as a module to the transport unit, as a result of which a processing device can be configured flexibly and in accordance with customer requests.

It can be provided in the case of one advantageous refinement that at least one drive segment of the supported transport unit is positioned with respect to an outer wall of the support unit. An outer wall can be, in particular, a wall of a support unit which separates the transport unit to the outside in a longitudinal extent, with the result that the supported transport unit advantageously does not fall out of the support unit when it carries out a stroke movement.

It can be provided in the case of one advantageous refinement that the processing station is configured to process the processing object and/or a content of the processing object (for example, upstream and/or downstream of the abovementioned action of force) without the action of force. As a result, the processing object and/or a content of the processing object can be processed without the action of force of the processing station. In this way, for example, a container can be filled in one preferred embodiment. The abovementioned processing force can serve, for example, to open a closure before filling and/or to close a closure after filling.

As an alternative or in addition, according to the invention, the features of the further independent claim which is directed to the use are provided to achieve the stated object. In particular, it is therefore proposed according to the invention, in order to achieve the stated object in the case of the use of the type mentioned at the outset, that a processing device as claimed above is used for closing pharmaceutical units and/or devices and/or for assembling medical devices. As a result of the use of a processing device according to the invention, pharmaceutical units and/or devices can be closed tightly, since a high processing force can be applied. The closure can also take place in a sterile manner, since the pharmaceutical vessels are moved by way of the transport device on a magnetically levitated transport unit. This is also advantageous when medical devices are being assembled, that is to say, in particular, medical apparatuses such as autoinjectors. In this way, the pharmaceutical units and/or the medical devices are protected against abrasion and contamination. A risk of contamination can likewise be reduced by virtue of the fact that the support unit including transport unit can increase the spacing from the electromagnetic stator arrangement described herein during the closure of the pharmaceutical units and/or devices. In this way, the pharmaceutical unit and/or the medical device can advantageously be closed at a distance from the floor.

It can also be provided that a plurality of transport units can act as abutment, since a plurality of transport units can absorb more force, with the result that a motionless support of the abutment is not required.

### BRIEF DESCRIPTION OF THE DRAWINGS

The invention will now be described in greater detail on the basis of exemplary embodiments, but is not restricted to these exemplary embodiments. Further exemplary embodiments result from the combination of the features of individual or multiple claims among one another and/or with individual or multiple features of the exemplary embodiments.

In the drawing:

FIG. 1 shows a processing device according to the invention,

FIG. 2 shows a processing device according to the invention with a transport unit which is situated in a support unit and is spaced apart from an electromagnetic stator arrangement,

FIGS. 3 and 4 show two alternative processing devices according to the invention, the transport units of which can be moved vertically,

FIGS. 5 and 6 show an alternative processing device according to the invention in a side view (FIG. 5) and a plan view (FIG. 6),

FIG. 7 shows an alternative processing device according to the invention with a support unit, the abutment of which can absorb a processing force in every direction, apart from in the transiting direction of the transport unit,

FIGS. 8 and 9 show two alternative processing devices according to the invention, the support units of which configure an active component,

FIGS. 10 and 11 show an alternative processing device according to the invention with an active component without contact (FIG. 10) and in contact (FIG. 11) with the transport unit,

FIGS. 12 and 13 show two alternative processing devices according to the invention for processing two (FIG. 12) and four (FIG. 13) syringes, and

FIG. 14 shows an alternative processing device according to the invention with a processing station which is surrounded partially by a stator arrangement.

### DETAILED DESCRIPTION

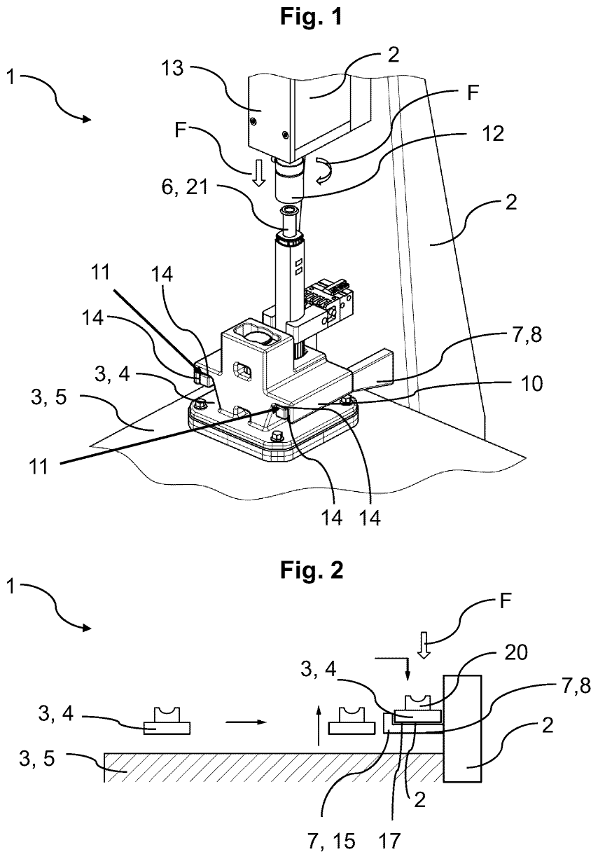

FIG. 1 shows a processing device 1 with at least one processing station 2 and at least one transport device 3, the transport device 3 being configured to transport at least one magnetically levitated transport unit 4 to and/or from the at least one processing station 2, the processing station 2 being configured to apply a processing force F to a processing object 6.

Forces are also applied laterally to a processing object 6 by way of a processing device 1 (not shown).

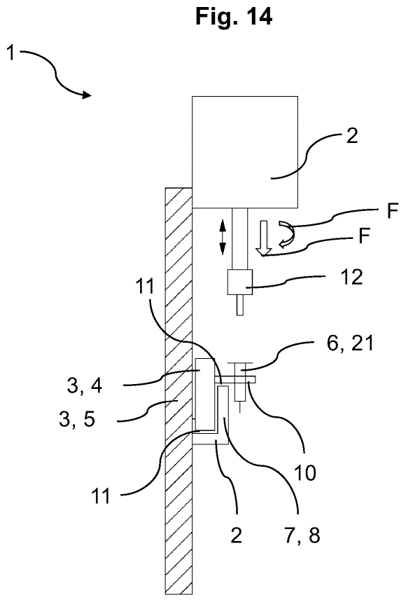

The processing object 6 is shown in FIGS. 1, 6 and 12 to 14, but is omitted from the other figures for the sake of improved clarity. The processing objects 6 in these other figures are situated on the object receptacle 20, however. A processing object 6 can be a pharmaceutical unit 21, in particular a syringe or a medical device such as an autoinjector or another medical device which is assembled from a plurality of parts and an action of force.

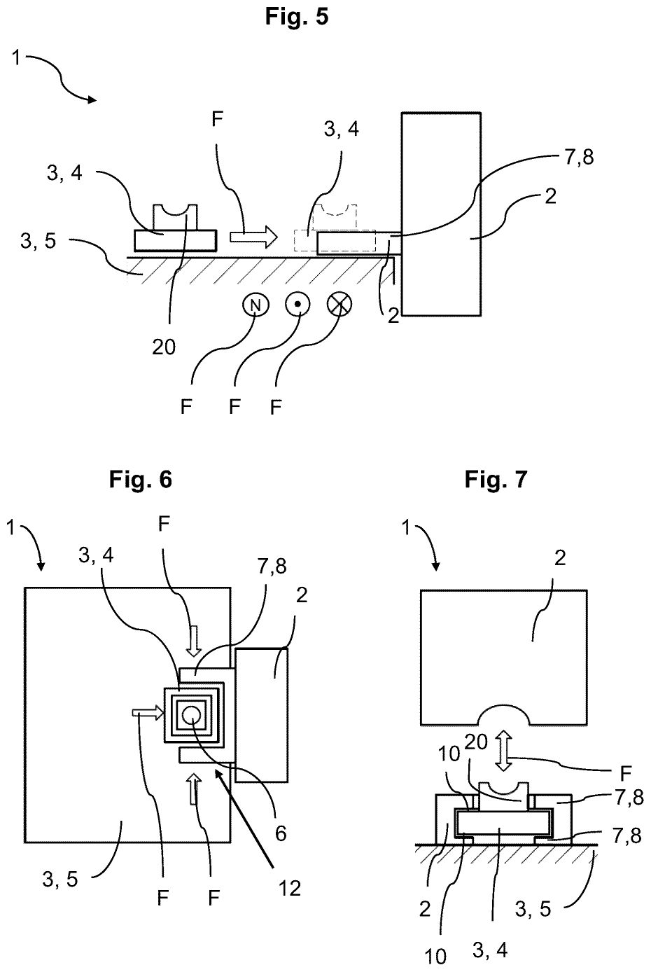

The processing station 2 can be configured to apply a tensile force and/or a compressive force and/or a torque and/or a torsional force as the processing force F, as is shown, for example, in FIGS. 1 to 14. Here, a straight arrow represents a tensile and/or compressive force, and a curved, downwardly directed arrow represents a torque (direction of the rotational axis with the direction according to the rotational direction). Further processing forces can also be provided which can be applied by way of the processing station 2. It can be provided, in particular, that different processing forces, for example the abovementioned tensile and compressive forces, are also introduced by way of the processing station 2 with an electric and/or magnetic origin (shown by way of an “N” situated in a circle), as is the case, for example, in the embodiment shown in FIG. 5. The embodiments of a processing station 2 which are shown in FIGS. 1 and 12 to 14 configure a press, by way of which the processing force F can be applied.

In embodiments which are not shown, processing stations 2 are configured at least like the embodiments in FIGS. 1 to 14 and, furthermore, are configured to process the processing object 6 and/or a content of the processing object 6 without the action of force. For example, a processing object 6 which is configured as a container can be filled by way of the processing station 2. The levitated transport unit 4 is coupled magnetically to the stator arrangement 5 and can be moved in at least two degrees of freedom. This is the case in all the embodiments. As a result, the transport unit 4 can be movable in a flexible manner, as a result of which an overall configuration of the processing device 1 can be flexible and according to the customer requirements.

The embodiments which are shown in all the figures are characterized in that the processing station 2 has at least one support unit 7, into which the at least one transport unit 4 can be moved, and the support unit 7 forming an abutment 8 counter to the processing force F. In this way, the abutment 8 can advantageously counteract the processing force F on the transport unit 4 in such a way that the transport device 3 is not damaged or even destroyed. In this way, a processing device 1 can be particularly improved.

The abutment 8 of the support units 7 is arranged in such a way that the supported transport unit 4 is arranged spaced apart from the stator arrangement 5 even in the case of a deactivated transport device 3.

The support unit 7 can be configured in a very wide variety of ways. As shown, in particular, in FIGS. 1, 2, 3, 7 and 9, it can be provided that the support unit 7 is configured in such a way that the transport unit 4 is configured with a variable spacing from an electromagnetic stator arrangement 5 at least in the support unit 7. The change in the spacing of the transport unit 4 from the stator arrangement 5 can be realized by virtue of the fact that the support unit 7 configures an active component 9 and lifts and/or supports the transport unit 4.

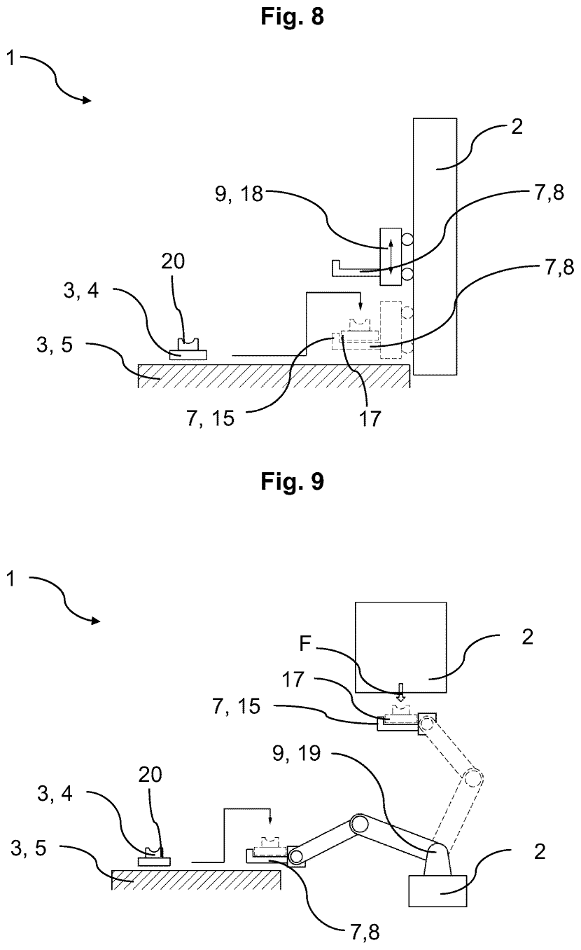

The active component 9 which is shown in FIG. 8 is configured as a movable carriage 18, the movable carriage 18 being configured such that it can be moved at the processing station 2 and lifting the transport unit 4 by way of moving. The support unit 7, 8 is configured on the active component 9, 18. Here, the drive of the active component 9, 18 can be brought about by way of energization of the transport unit 4 of the transport device 3.

The active component 9 which is shown in FIG. 9 is configured as a lifting robot 19 which can lift the transport unit 4 and move it to the processing station 2.

It can be seen in the embodiments of FIGS. 8 and 9 that the abutment 8 is arranged in such a way that the one transport unit 4 makes contact with the abutment 8 within its stroke travel. Here, as also in other figures, the movement is illustrated by virtue of the fact that an element which is shown by way of continuously drawn dashes is moved from a starting position to a further position (dashed illustration of the element).

Lifting of the transport unit 4 can also be realized by way of energization of the stator arrangement 5, as realized, in particular, by the embodiments of FIGS. 1 to 3.

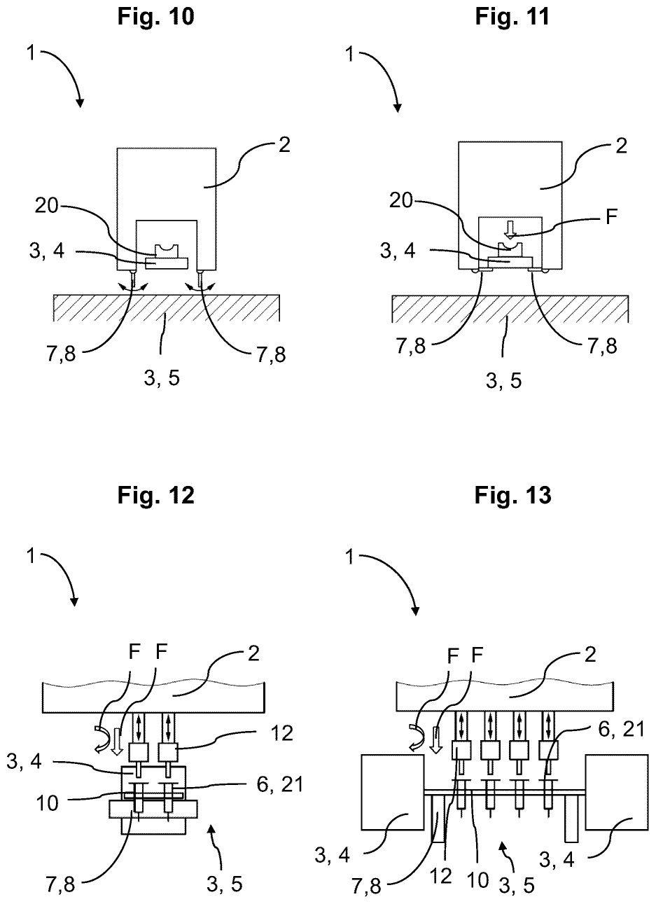

The embodiment which is shown in FIGS. 10 and 11 shows a movable support unit 7, 8 which supports the transport unit 4 as soon as the transport unit 4 has moved into the cavity of the processing station 2. Here, the support unit 7, 8 is of foldable configuration. As can be seen in FIG. 11, the support unit 7, 8 blocks the transport unit 4 in three degrees of freedom, in particular after the abutment 8 has been activated by way of the docking transport unit 4. In this way, the transport unit 4 is secured during the processing by way of the processing station 2, and cannot fall out of the processing station 2. Similar securing, the transport unit 4 being secured by way of the processing station 2 counter to its entry direction, is realized in the embodiments of FIGS. 2, 3, 8 and 9.

In the embodiments of FIGS. 1 to 7 and 12 to 14, the support unit 7, 8 is arranged in a spatially fixed manner with respect to the processing station 2.

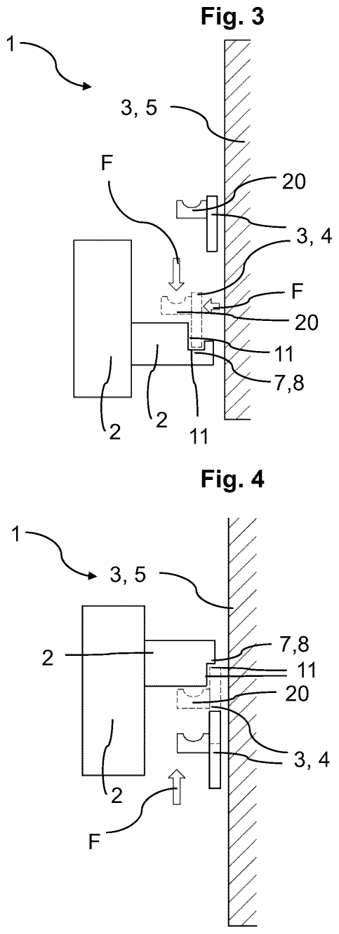

The abutment 8 of all the embodiments shown is configured in a fitting manner with respect to a counter-abutment 10 on the at least one transport unit 4, in particular in order to establish a connection which is positively locking (in particular, FIGS. 1 and 7) and/or non-positive (in particular, FIG. 7) and/or brought about via magnetic forces (FIGS. 3 and 4).

FIG. 7 shows, furthermore, that the abutments 8 of the processing station 2 are configured to form a tunnel which is not completely closed and, on its lower side and upper side, can counteract a tensile force (upper side) or compressive force (lower side). The abutments 8 in the case of this embodiment are configured in such a way that the abutments 8 can absorb a processing force F in every direction, with the exception of a passage direction of the transport unit 4.

In one embodiment (not shown), the embodiment which is shown in FIG. 7 is not configured as a tunnel, but rather as a garage, with the result that the transport unit 4 can enter and exit through merely one opening of the processing station 2.

In FIGS. 1, 2 and 5 to 11, the abutment 8 is arranged parallel to the stator arrangement 5, and has an extent which is at least 1.2 times longer than a contact region 11 between the abutment 8 and the counter-abutment 10 (see, in particular, FIG. 1). In this way, the transport unit 4 can dock securely on the support unit 7, 8 and can be supported during the processing.

The abutment 8 can also be arranged in a non-parallel, in particular perpendicular, manner with respect to the stator arrangement 5, as can be seen, for example, in the embodiments of FIGS. 3, 4 and 12 to 14. A non-parallel arrangement is advantageous, in particular, when the transport unit 4 can be moved on a vertical wall and docks on the processing station 2.

The embodiment 1 shows a load cell 13 of the processing station 2, which load cell 13 can advantageously measure, in particular, the processing force F. Although not shown, the load cell 13 can also be present in the processing stations 2 of the further embodiments.

The load cell 13 can also measure a holding force. This is advantageous, in particular, when (as in the embodiments which are shown) the processing force F is greater than a holding force of the transport unit 4. In this way, processing by way of the processing device 1 can be monitored and carried out in an optimum manner.

The abutment 8 of the embodiments which are shown has also configured at least two contact surfaces 11 with the counter-abutment 10, with the result that the transport unit 4 makes contact with the support unit 7 on at least two sides. As a result, the transport unit 4 can be particularly secured, in particular during the processing. Furthermore, as a result, the at least one drive segment 17, for example an electromagnet and/or permanent magnet, of the supported transport unit 4 can be positioned with respect to an outer wall 15 of the support unit 7, as is shown by way of example in FIGS. 2, 8 and 9.

In order to save space, in particular, the support unit 7 can be surrounded at least partially by the stator arrangement 5. In the embodiments in FIGS. 12 to 14, the support unit 7, 8 is surrounded completely by the stator arrangement 5. As a result, the transport unit 4 can move around the support unit 7, 8 and can dock to it in an optimum manner.

The embodiments which are shown are used, in particular, to close pharmaceutical units 6, 21. For example, pharmaceutical units 6, 21 can be syringes, as are shown, in particular, in FIGS. 12 to 14. Furthermore, pharmaceutical devices and/or medical devices can be processed by way of the embodiments.

The invention generally proposes a processing device 1 with at least one processing station 2 and at least one transport device 3, the transport device 3 being configured to transport at least one magnetically levitated transport unit 4, configured to receive a processing object 6, to and/or from the at least one processing station 2, the processing station 2 being configured to apply a processing force F to a processing object 6, and the processing station 2 having at least one support unit 7, to which the at least one transport unit 4 can be coupled, and the support unit 7 forming an abutment 8 against the processing force F.

### List of Designations

1 Processing device
2 Processing station
3 Transport device
4 Transport unit
5 Electromagnetic stator arrangement
6 Processing object
7 Support unit
8 Abutment
9 Active component
10 Counter-abutment
11 Contact region between 8 and 10
12 Press
13 Load cell
14 Contact surface
15 Outer wall of 7
17 Drive segment of 4
18 Carriage
19 Lifting robot
20 Object receptacle
21 Pharmaceutical unit
F Processing force

1. A processing device (1), comprising:
at least one processing station (2) and at least one transport device (3), the transport device (3) being configured to transport at least one magnetically levitated transport unit (4), which is configured to receive a processing object (6), at least one of to or from the at least one processing station (2),
the processing station (2) being configured to apply a processing force (F) to the processing object (6), and
the processing station (2) has at least one support unit (7), to which the at least one transport unit (4) is couplable, and the support unit (7) forms an abutment (8) against the processing force (F).

2. The processing device as (1) claimed in claim 1, wherein the transport unit (4) is configured with a variable spacing from an electromagnetic stator arrangement (5) at least in the support unit (7), such that a volume between the transport unit (4) and the stator arrangement (5) is increasable, the variable spacing being configured by of energization of at least one of the electromagnetic stator arrangement or a further stator arrangement (5).

3. The processing device (1) as claimed in claim 1, wherein at least one of a) the support unit (7) forms an active component (9) and at least one of lifts or supports the transport unit (4), or b) the support unit (7) is arranged in a spatially fixed manner with respect to the processing station (2).

4. The processing device (1) as claimed in claim 1, wherein of the support unit (7) is arranged movably for movement by a drive of the transport device (3), the support unit (7) being configured, with at least two coupled ones of the transport units (4) of a further one of the transport devices (3).

5. The processing device (1) as claimed in claim 1, wherein the abutment (8) is configured complementarily with respect to a counter-abutment (10) on the at least one transport unit (4), to establish a connection via magnetic forces.

6. The processing device (1) as claimed in claim 1, wherein the abutment (8) is configured such that the supported transport unit (4) is arranged spaced apart from an electromagnetic stator arrangement (5) of the at least one transport unit (4) even in the case of a deactivated transport device (3).

7. The processing device (1) as claimed in claim 1, wherein the abutment (8) is arranged such that the at least one transport unit (4) makes contact with the abutment (8) within a stroke travel thereof.

8. The processing device (1) as claimed in claim 1, wherein the abutment (8) is arranged parallel and/or transversely with respect to the stator arrangement (5).

9. The processing device (1) as claimed in the processing device is configured to apply at least one of: a tensile force, a compressive force, a torque, or a torsional force as the processing force (F).

10. The processing device (1) as claimed in claim 1, wherein the processing station (2) has a press (12), by which the processing force (F) is adapted to be applied.

11. The processing device (1) as claimed in claim 1, wherein the processing force (F) is greater than a holding force of the transport unit (4).

12. The processing device (1) as claimed in claim 1, wherein the abutment (8) is adapted to be activated by way of the docking transport unit (4).

13. The processing device (1) as claimed in claim 1, wherein the support unit (7) is surrounded at least partially by an electromagnetic stator arrangement (5) of the at least one transport unit (4).

14. The processing device (1) as claimed in claim 1, wherein the processing station (2) is configured to process at least one of the processing object (6) or a content of the processing object (6) without the action of force.

15. The a processing device (1) as claimed in claim 1, wherein the processing object (6) comprises pharmaceutical units (21) to be closed and/or medical devices to be assembled.

16. The processing device (1) as claimed in claim 1, wherein the abutment (8) has an extent which is at least or at most 1.2 times longer than a contact region (11) between the abutment (8) and a counter-abutment (10).

17. The processing device (1) as claimed in claim 1, wherein the processing station (2) has a load cell (13).

18. The processing device (1) as claimed in claim 1, wherein the support unit (7) is configured to block at least two degrees of freedom of the transport unit (4).

19. The processing device (1) as claimed in claim 1, wherein the abutment (8) includes at least three contact surfaces (14) with the counter-abutment (10).

20. The processing device (1) as claimed in claim 1, wherein at least one drive segment (17) of the supported transport unit (4) is positioned with respect to an outer wall (15) of the support unit (7).
